(19) United States
(12) Patent Application Publication
(10) Pub. No.: US 2024/0197092 A1
(43) Pub. Date: Jun. 20, 2024

(54) FACE PILLOW WITH INSIDE AIR CHANNEL

(71) Applicant: QINGLIN QIU, Broomfield, CO (US)

(72) Inventor: QINGLIN QIU, Broomfield, CO (US)

(21) Appl. No.: 18/082,582

(22) Filed: Dec. 16, 2022

(51) Int. Cl. A47G 9/10; A61G 13/00; A61G 13/12

(52) U.S. Cl. CPC A47G 9/1054; A61G 13/009; A61G 13/121; A47G 2009/1018; A61G 2200/325

(57) ABSTRACT

In the current marketing, the standard prone position face pillow always requires a air hole on a massage table and massage mat, and some new designed face pillow which has breathing air channel itself, always follow the concepts of “pillow+air channel”, so that these face pillows have “footer” attached, its height is always higher than the regular face pillow, so we cannot use it in the standard massage and beauty services. This invention is to design a inside air channel within the face pillow, which split the filler into two parts on two tiers. Tier 1 filler is to support client's face; tier2 filler is placed underneath the tier 1 filler, That has a horizontal breathing air channel. So we can use this new face pillow anywhere, and its size is the same with conventional products.

### BACKGROUND OF THE INVENTION

In the current marketing, the standard face pillow used in prone position always requires an air hole on a massage table or massage mat, and some new designed face pillow that has breathing air channel itself, but it always follows the concepts of “pillow+air channel”, so that these face pillows have “footer” attached. The height of face pillow is always higher than the regular face pillow, so people cannot use it in the standard massage and beauty services.

### SUMMARY OF THE INVENTION

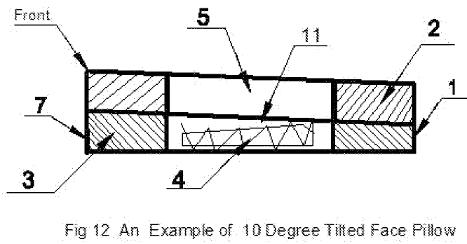

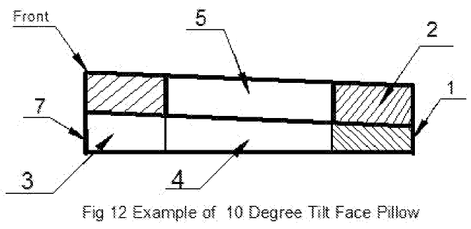

This invention is to create a new face pillow (FIG. 12), which has a inside breathing air channel within the face pillow (4,5), and assembled by 3 components:
A. Tier 1 filler (2), which is made of softer sponge, its outside diameter is about 8 inches, and has a 3.5-4 inches diameter round hole (5) in the middle, and in order to fit human face shape, modify the round hole into oval shape. The thickness of tier 1 filler (2) is the 50% height of the entire face pillow.
B. Tier 2 filler (3), which is made of harder foam material, such as EPE foam, its outside diameter is the same as tier 1 filler (2), and also has a half-round hole (4) in the middle as of a part of vertical breathing air channel (4). However, this air channel (4) is extended to the front edge, 2 inches wide open space to lead breathing air going out. The thickness of tier 2 filler (3) is also the 50% height of entire face pillow.
C. Leather coverings (1), which wrap entire tier 1 filler (2) and tier 2 filler (3) together, and formed by 4 pieces:
a. bottom round piece (8);
b. a long strip on the height surroundings (9), on which there is a open long square slot (7) in the front to become the outlet of flowing air (7);
c. a flat ring shape piece on the top (10);
d. a hanging ring shape curtain (6) connected with top flat ring shape piece (10).

FIG. 10 is an example of this invention. We can have the tier 2 filler (3) has a small angel (10 to 15 degree) to against horizontal direction, so the tier 1 filler (2) can be assembled in a small angel, more fit the human face. Furthermore, massage therapist and other user can place a small piece of disposable sterile gauze (11) into vertical air channel (5), which is able to against germs and pandemics to reduce cross infections. So we can use this new face pillow anywhere, and the size is the same with conventional products, that can meet the spa health requirements

### BRIEF DESCRIPTION OF THE DRAWINGS

### Figures

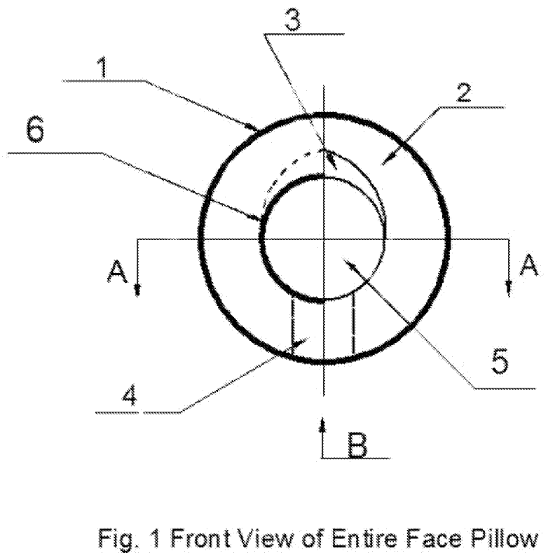

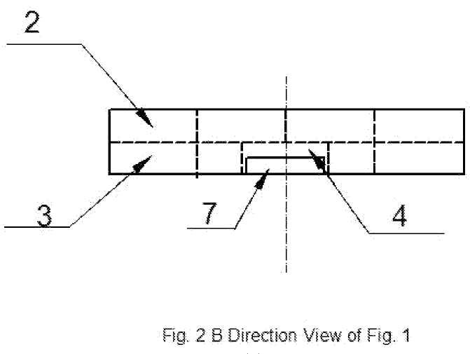

FIG. 1 is the Front View of Entire Face Pillow

FIG. 2 is B Direction View of FIG. 1

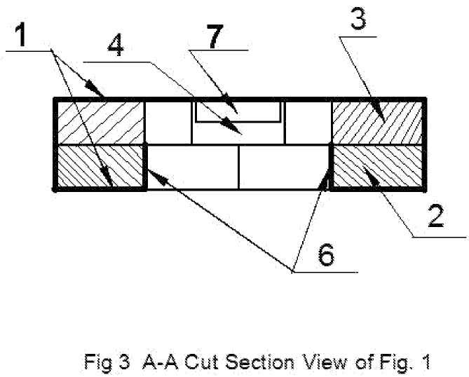

FIG. 3 is A-A Cut Section View of FIG. 1

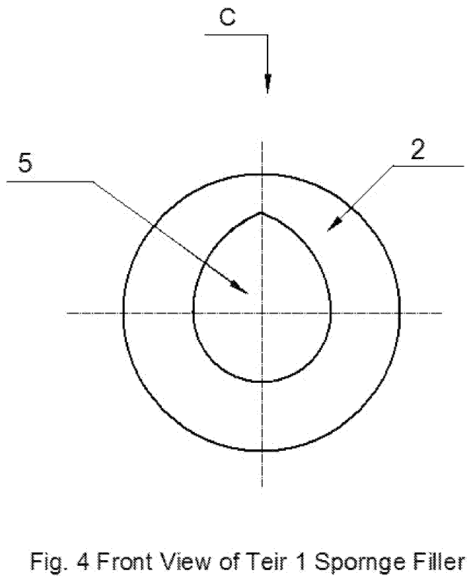

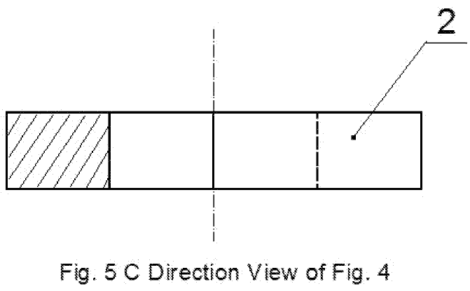

FIG. 4 is Front View of Tier 1 Filler

FIG. 5 is C Direction View of FIG. 4

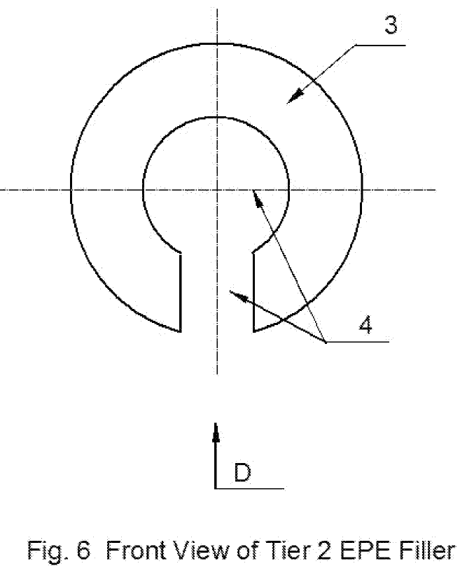

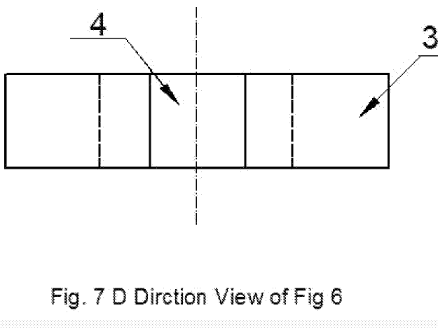

FIG. 6 is Front View of Tier 2 Filler

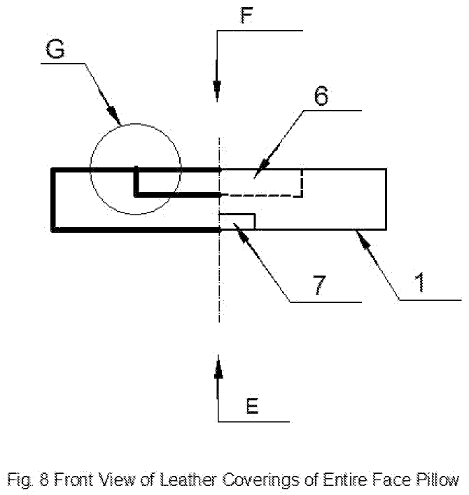

FIG. 7 is D Direction View of FIG. 6

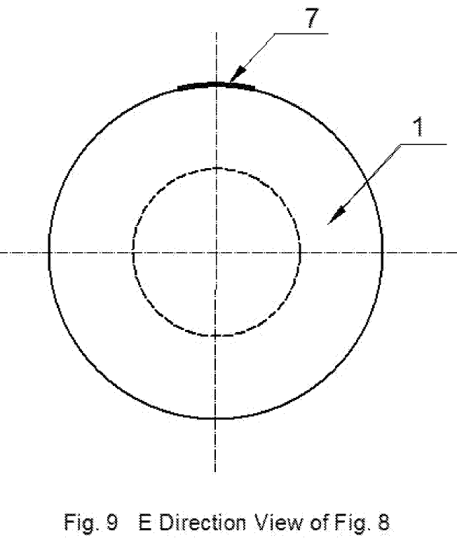

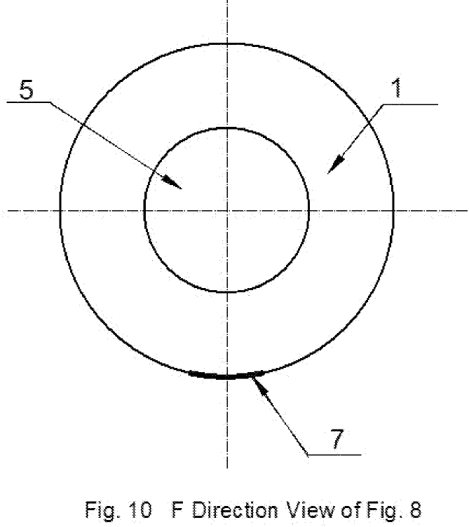

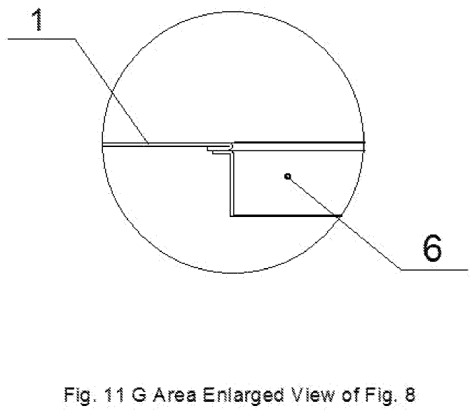

FIG. 8 is Front View of Leather Coverings of Entire Face Pillow

FIG. 9 is E Direction View of FIG. 8

FIG. 10 is F Direction View of FIG. 8

FIG. 11 is G Area Enlarged View of FIG. 8

FIG. 12 is An Example of 10 Degree Tilted Face Pillow

### DETAILED DESCRIPTION OF THE DRAWINGS

With reference now to the drawings, and in particular FIGS. 1 through 11, thereof, example of the instant A Face Pillow with Inside Air Channel employing the principles and concepts of the present Face Pillow with inside air channel and generally designated shown on FIG. 12.

The present A Face Pillow with Inside Air Channel (FIG. 12) has been designed to enable a user to perform any massage or beauty work upon clients' prone position, so that the clients feel comfortable; even though there is no breathing hole on the massage table or a massage cushion. Because there is a vertical breathing hole (5) in the middle of Face Pillow, and a horizontal air channel (4) in the tier 2 filler (3), so that the client's breathing air can flow out through the long square slot (7)

What is claimed is:

1. A Face Pillow with Inside Air Channel for use in massage or cosmetic treatment, said A Face Pillow with Inside Air Channel compromising three independent components, comprising:
(A). Leather coverings, consisting of top ring-shape piece, bottom round piece, and height surroundings, as well as the hanging ring-shape curtain in the vertical air channel. And there is a long square slot (air outlet) on the front location.
(B) Tier 1 filler, which is made of regular sponge, there is a vertical ellipse shape hole on the middle.
(C). Tier 2 filler, which is made of harder foam, e.g. EPE foam, there is a half-round hole in the middle, same outside size and hole diameter with tier 1. and a two inch wide open space connected vertical air channel and the outlet for air flow.

2. A Face Pillow with Inside Air Channel claim 1, wherein the leather coverings further comprises a long square air outlet in the front, and a ring-shape hanging curtain in the vertical breathing air hole.

3. A Face Pillow with Inside Air Channel claim 1, wherein the tier 1 filler further comprising a ellipse hole in the middle, its height is 50% of entire face pillow.

4. A Face Pillow with Inside Air Channel claim 1, wherein the tier 2 filler further comprising a half-round hole and two inch wide open space for the air flow.
